(19) United States
(12) Patent Application Publication
(10) Pub. No.: US 2017/0293450 A1
(43) Pub. Date: Oct. 12, 2017

(54) Integrated Flash Management and Deduplication with Marker Based Reference Set Handling

(71) Applicant: HGST Netherlands B.V., Amsterdam (NL)

(72) Inventors: Ajith Kumar Battaje, Karnataka (IN); Tanay Goel, Chhattisgarh (IN); Saurabh Manchanda, Delhi (IN); Sandeep Sharma, Karnataka (IN)

(21) Appl. No.: 15/095,292

(22) Filed: Apr. 11, 2016

(51) Int. Cl. G06F 3/06

(52) U.S. Cl. CPC G06F 3/0641; G06F 3/0604; G06F 3/0679

(57) ABSTRACT

A system and method for integrating flash management and deduplication with marker based reference set handling may include a dynamic reference set that is elastic and can include non-contiguous reference blocks. The method may further include determining the first reference block of the plurality of reference blocks for continued encoding, the first reference block having an identifier, and associating the identifier of the first reference block with a second reference set. Some implementations of the method may further include receiving a first plurality of data blocks in an incoming data stream, the first plurality of data blocks including a first data block, and encoding the first data block using the first reference block associated with the second reference set.

### BACKGROUND

The present disclosure relates to managing data blocks in a storage device. In particular, the present disclosure relates to aggregating reference blocks into a reference set for deduplication in flash memory. Still more particularly, the present disclosure relates to maintaining and tracking reference sets on a deduplication system based on similarity based content matching for storage applications and data deduplication.

High performance non-volatile storage systems are becoming prevalent as a new level in traditional storage hierarchy. It is desirable to decrease the amount of storage space used on such storage systems in order to decrease the total cost of such storage systems. One way in which existing methods attempt to reduce the amount of storage space used is by data deduplication. Existing methods may perform data deduplication by comparing each corresponding data block of an incoming data stream to a data block in storage. For example, existing methods may record reference blocks against which data blocks are encoded. Some existing methods may aggregate reference blocks into static sets of data blocks. However, because an incoming data stream may change requiring changes to reference blocks, such existing methods can cause unbounded growth of storage space required for the reference sets in the storage system or in main computer memory.

Additionally, some high performance non-volatile storage systems, such as flash memory, degrade over write cycles, so the number of unnecessary write cycles should be kept to a minimum. Some existing methods use static sets of reference data that must be rewritten as data stream changes and during garbage collection.

Existing methods include many drawbacks and performance issues, such as increased latency, additional storage use, additional read/write cycles, inefficient garbage collection, and tracking of which data block is currently referring to which reference block. The present disclosure solves problems associated with data aggregation in storage devices by efficiently aggregating reference blocks into reference sets.

### SUMMARY

The techniques described in the present disclosure relates to systems and methods for integrating flash management and deduplication with marker based reference set handling. According to one innovative aspect of the subject matter in this disclosure, a system comprises a dynamic reference set for associating encoded data blocks to reference blocks, the dynamic reference set including a plurality of non-contiguous reference blocks; a reduction unit having an input and an output for encoding data blocks using the reference blocks in the dynamic reference set, the input of the reduction unit coupled to receive data from a data source; a media processor having an input and an output for dynamically associating identifiers of reference blocks with the dynamic reference sets, the input of the media processor coupled the reduction unit to receive reference blocks; and a storage device capable of storing data, the storage device having an input and an output coupled to the reduction unit and the media processor for reading data from and storing data to the storage device.

In general, another innovative aspect of the subject matter described in this disclosure may be implemented in methods that include: associating identifiers of a plurality of reference blocks with a first reference set, the plurality of reference blocks including a first reference block having a first identifier; selecting the first reference block of the plurality of reference blocks for continued use; associating the first identifier of the first reference block with a second reference set, the second reference set having a second plurality of reference blocks, the first reference block being non-contiguous with the second plurality of reference blocks; receiving an incoming data stream of data blocks; and encoding the incoming data stream of data blocks using the second reference set.

In general, another innovative aspect of the subject matter described in this disclosure may be implemented in methods that include: receiving a data block; encoding the data block using a reference block associated with a reference set; storing the encoded data block in an initial segment in a storage device, the initial segment being a first segment encoded using the reference set; determining a marker number of the initial segment based on a segment sequence number of the initial segment; and recording an association of the marker number of the initial segment with the reference set in metadata of the reference set.

Other implementations of one or more of these aspects include corresponding systems, apparatus, and computer programs, configured to perform the actions of the methods, encoded on computer storage devices.

These and other implementations may each optionally include one or more of the following features. For instance, the operations may further include: storing a first encoded data block of the incoming data stream of data blocks in a first segment associated with the second reference set; determining a marker number of the first segment associated with the second reference set; storing the marker number of the first segment in metadata of the second reference set; that the marker number of the first segment associated with the second reference set includes a segment sequence number of the first segment, and the first segment is an initial segment to be written using the second reference set; that the second reference set includes a dynamic quantity of reference blocks and/or is dynamically sized; that associating the identifier of the first reference block with the second reference set includes adding the identifier of the first reference block to a membership bitmap of the second reference set; generating a second reference block based on the incoming data stream, the second reference block having a second identifier; associating the second identifier of the second reference block with the second reference set; determining to retire the first reference set based on a defined criterion, and wherein associating the first identifier of the first reference block with the second reference set is in response to the determination to retire the first reference set; encoding the incoming data stream of data blocks using the second reference set includes deduplicating a data block of the incoming stream of data blocks using the first reference block against a past data block encoded using the first reference block; a submission queue unit having an input and an output for storing an encoded first data block in a first segment associated with the dynamic reference set in the storage device the input of the submission queue unit coupled to the reduction unit and the output of the submission queue unit coupled to the storage device; that the media processor is further configured to determine a marker number of the first segment in the storage device, and associate the marker number of the first segment in metadata of the dynamic reference set; that the marker number of the first segment associated with the dynamic reference set includes a segment sequence number of the first segment, and the first segment is an initial segment to be written using the dynamic reference set; that the dynamic reference set includes a membership bitmap, the membership bitmap storing the association between data blocks and reference blocks; a command queue unit having an input and an output for receiving a plurality of data blocks in an incoming data stream, the input of the command queue unit coupled to the data source and the output of the command queue unit coupled to the reduction unit; that the reduction unit is further configured to generate a new reference block based on the plurality of data blocks in the incoming data stream, the new reference block having a new identifier; that the media processor is further configured to associate the new identifier with the dynamic reference set; that the media processor is further configured to determine to retire a first dynamic reference set based on a defined criterion, and associate identifiers of one or more reference blocks of the first dynamic reference set with a second dynamic reference set in response to the determination to retire the first dynamic reference set; that the reduction unit is configured to deduplicate a first data block using a reference block against a second data block encoded using the reference block; receiving a request to retrieve the data block from the storage device; identifying the reference set based on the recorded association between the initial segment and the reference set in the metadata of the reference set; decoding the encoded data block using the reference block to generate the data block; and returning the data block; and that the reference set is dynamically sized and includes a plurality of non-contiguous reference blocks.

These implementations are particularly advantageous in a number of respects. For instance, the techniques described in the present disclosure reduce latency, memory use, and write cycles by efficiently maintaining and tracking reference sets on a deduplication system using similarity based content matching. Additionally, the techniques described herein allow a reduction in cost of data storage and fewer write cycles to a storage system, especially due to garbage collection.

It should be understood that language used in the present disclosure has been principally selected for readability and instructional purposes, and not to limit the scope of the subject matter disclosed herein.

### BRIEF DESCRIPTION OF THE DRAWINGS

The present disclosure is illustrated by way of example, and not by way of limitation in the figures of the accompanying drawings in which like reference numerals are used to refer to similar elements.

FIG. 1 is a high-level block diagram illustrating an example system for integrating flash management and deduplication with marker based reference set handling.

FIG. 2 is a block diagram illustrating an example of storage logic according to the techniques described herein.

FIGS. 3A and 3B are flow charts of an example method for creating a new active reference set and managing encoded data blocks associated with the new active reference set.

FIG. 4 is a graphical representation illustrating an example data organization where markers are determined based on segment sequence numbers and saved to a reference set.

FIGS. 5A and 5B are flow charts of an example method for encoding data blocks and aggregating corresponding reference blocks into reference sets.

FIG. 6A is a graphical representation illustrating an example prior art data organization for static reference sets.

FIG. 6B is a graphical representation illustrating an example data organization for dynamic reference sets.

FIG. 6C is a graphical representation illustrating example membership bitmaps.

FIG. 7 is a flow chart of an example method for retrieving an encoded data block from a data store.

### DETAILED DESCRIPTION

Systems and methods for integrating flash management and deduplication with marker based reference set handling are described below. While the systems and methods of the present disclosure are described in the context of particular system architecture that uses flash-storage, it should be understood that the systems and methods can be applied to other architectures and organizations of hardware and other memory devices with similar properties.

The present disclosure addresses the problem of maintaining and tracking blocks of reference data in set on a deduplication system. Some implementations of the techniques described herein use similarity based deduplication as opposed to exact matching among a set of documents for storage and data deduplication. Tracking the association of individual reference blocks with individual data blocks is more resource intensive (e.g., requires more processing time and memory usage) than tracking the association of reference blocks with data blocks in an aggregate manner. In particular, the techniques described herein improve upon past methods for tracking reference blocks by dynamically associating reference blocks to reference sets and efficiently managing utilization of reference sets using markers.

A reference set includes a set or association of reference blocks. In some implementations a reference set may include a data structure having a header and metadata and additional information, such as references to identifiers of reference blocks or reference blocks themselves. A reference block is a data structure that may be used to encode and decode a data block. A reference block may include a header with an identifier and reference data.

Similarity based deduplication techniques may include, for example, an algorithm to detect similarity between data blocks using Rabin Fingerprinting and Broder's document matching schemes. Furthermore, similarity-based deduplication algorithms operate by deducing an abstract representation of content associated with reference blocks. Thus, reference blocks can be used as templates for deduplicating other (i.e., future) incoming data blocks, leading to a reduction in total volume of data being stored. When deduplicated data blocks are recalled from storage, the encoded (e.g., deduplicated) representation can be retrieved from the storage and combined with information supplied by the reference block(s) to reproduce the original data block. Such techniques may include grouping reference blocks into reference sets, using statistics to identify which reference blocks are hot (e.g., most frequently used to encode data blocks in an incoming data stream) or stale (e.g., least frequently used to encode data blocks in an incoming data stream). These techniques may further integrate reclaiming of reference blocks and reference sets using garbage collection.

For the purposes of this disclosure, encoding means any preparation of data for storage or transmission. In some implementations, encoding may include any form of data reduction, such as compression, deduplication, or both. For example, this disclosure includes deduplication methods and may use the terms deduplication, compression, and reduction (or variations of these terms in addition to or interchangeably with the terms encoding and decoding. It should be understood that, although methods of deduplication and use thereof are disclosed, implementations of the techniques described herein may be applicable to any type of encoding that may make use of reference data.

The elastic sizing of reference sets achieves improved deduplication ratios by allowing a larger quantity of reference blocks to be part of an active reference set, so a greater variety of a reference blocks are available to encode incoming data blocks. An active reference set is a set of reference blocks that are used for ongoing deduplication of data blocks in an incoming data stream. Once a reference set is no longer active, the blocks of that reference set are not used to deduplicate new data blocks in the incoming data stream, unless those blocks are also part of the currently active reference set, according to the techniques described herein. A reference set that is no longer active may still be used to decode the data blocks that were encoded using that reference set (e.g., when that reference set was active).

The techniques described herein further improve deduplication techniques and reference set management by enabling dynamic association of reference blocks to reference sets and elastic sizing of reference sets. These techniques enable fast switching of reference sets, because reference data of a hot reference block doesn't need to be copied to a new reference block and the identification of a reference block itself can be carried forward to a new active reference set. During garbage collection, carrying forward reference blocks in reference sets, allows data blocks using these reference blocks to be garbage collected in reduced form thereby minimizing write cycles, because data blocks do not have to be re-encoded.

Further, the techniques described herein associate chunks of contiguous physical space (e.g., to which a data block may be written) referred to as segments to a reference set using markers, thus reducing the memory required to track the association between data blocks and a reference block set. These marker based reference set handling techniques provide for fewer write cycles and decreased input/output (“I/O”) latency because metadata may be updated when a new reference set is created, rather than each time a segment is activated. Similarly, these marker based reference set handling techniques provide for easier recovery from an unplanned shutdown due to the minimal metadata that is generated at the time a reference set is created. Because the reference sets and associated metadata may be created outside of the I/O path, I/O path latency is decreased.

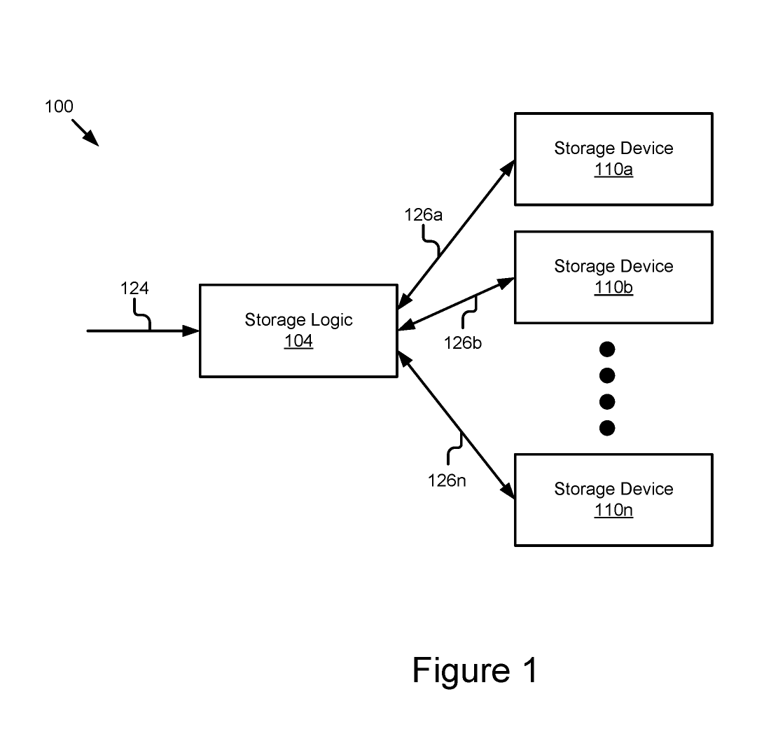

FIG. 1 is a high-level block diagram illustrating an example system 100 for integrating flash management and deduplication with marker based reference set handling according to the techniques described herein. In the depicted implementation, the system 100 may include storage logic 104 and one or more storage devices 110a, 110b through 110n. In some implementations, the storage logic 104 and the one or more storage devices 110a, 110b through 110n may be communicatively coupled via a switch (not shown). However, the present disclosure is not limited to this configuration and a variety of different system environments and configurations can be employed and are within the scope of the present disclosure. Other implementations may include additional or fewer components. It should be recognized that an indication of a letter after a reference number or numeral, for example, “110a” is a specific reference to the element or component that is designated by that particular reference numeral. In the event a reference numeral appears in the text without a letter following it, for example, “110,” it should be recognized that such is a general reference to implementations of the element or component bearing that general reference numeral.

In some implementations, the storage logic 104 provides integrated flash management and deduplication with marker based reference set handling. The storage logic 104 can provide computing functionalities, services, and/or resources to send, receive, read, write, and transform data. The storage logic 104 may receive an incoming data stream from some other device or application via signal line 124 and provide inline data reduction for a data stream and communicated to the storage devices 110a, 110b through 110n. In some implementations, the storage logic 104 can be a computing device configured to make a portion or all of the storage space available on storage devices 110. The storage logic 104 is coupled via signal lines 126a, 126b, through 126n for communication and cooperation with the storage devices 110a-110n of the system 100. In other implementations, the storage logic 104 transmits data between the storage devices 110 via a switch or may have a switch integrated with the storage logic 104. It should be recognized that multiple storage logic units 104 can be utilized, either in a distributed architecture or otherwise. For the purpose of this application, the system configuration and operations performed by the system are described in the context of a single storage logic 104.

A switch (not shown) can be a conventional type and may have numerous different configurations. Furthermore, the switch 106 may include an Ethernet, InfiniBand, PCI-Express switch, and/or other interconnected data paths switches, across which multiple devices (e.g., storage devices 110) may communicate.

The storage devices 110a, 110b through 110n, may include a non-transitory computer-usable (e.g., readable, writeable, etc.) medium, which can be any non-transitory apparatus or device that can contain, store, communicate, propagate or transport instructions, data, computer programs, software, code routines, etc., for processing by or in connection with a processor. In some implementations, the storage devices 110a, 110b through 110 communicate and cooperate with the storage logic 104 via signal lines 126a, 126b though 126n. While the present disclosure references the storage devices 110 as flash memory, it should be understood that in some implementations, the storage devices 110 may include a non-transitory memory such as a hard disk drive (HDD), a dynamic random access memory (DRAM) device, a static random access memory (SRAM) device, or some other memory devices.

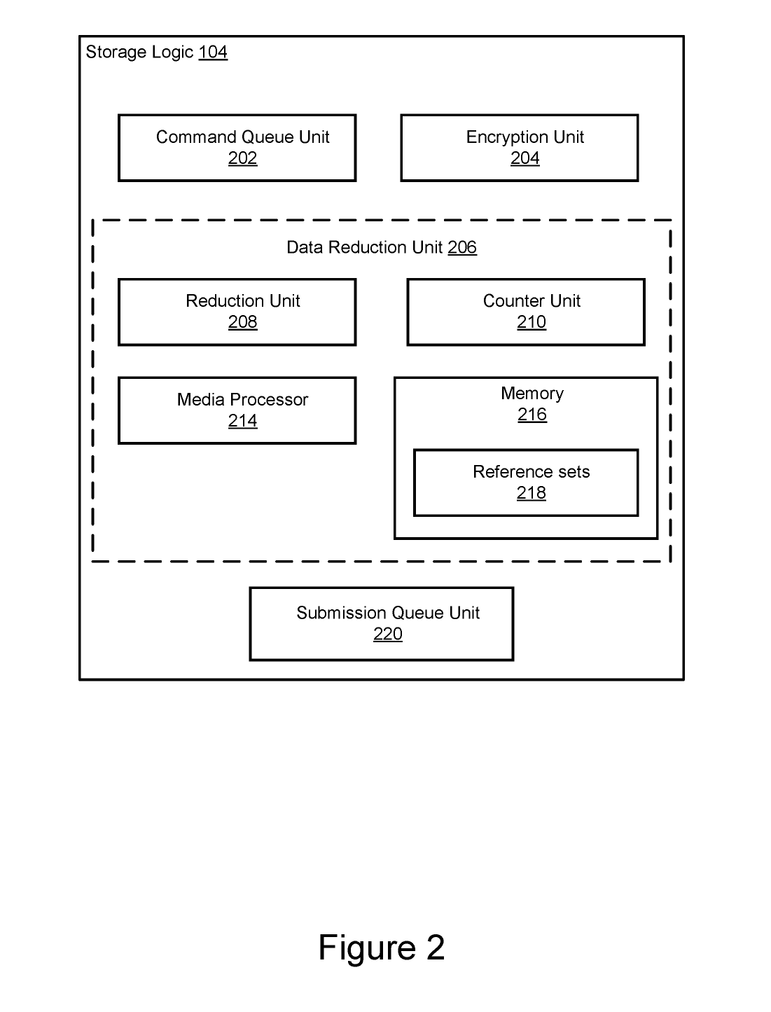

FIG. 2 is a block diagram illustrating an example implementation of storage logic 104 according to the techniques described herein. The storage logic 104 may include logic, firmware, software, code, or routines or some combination thereof for integrating flash management and deduplication with marker based reference set handling. As depicted in FIG. 2, the storage logic 104 may include a command queue unit 202, an encryption unit 204, a data reduction unit 206, and a submission queue unit 220, which may be electronically communicatively coupled by a communication bus (not shown) for cooperation and communication with each other, although other configurations are possible. These components 202, 204, 206, and 220 are also coupled for communication with the other entities (e.g., storage devices 110) of the system 100.

In one implementation, the command queue unit 202, encryption unit 204, data reduction unit 206, and submission queue unit 220 may be hardware for performing the operations described below. In some implementation, the command queue unit 202, encryption unit 204, data reduction unit 206, and submission queue unit 220 are sets of instructions executable by a processor or logic included in one or more customized processors, to provide its respective functionalities. In some implementations, the command queue unit 202, encryption unit 204, data reduction unit 206, and submission queue unit 220 are stored in a memory and are accessible and executable by a processor to provide its respective functionalities. In further implementations, the command queue unit 202, encryption unit 204, data reduction unit 206, and submission queue unit 220 are adapted for cooperation and communication with a processor and other components of the system 100. The particular naming and division of the units, modules, routines, features, attributes, methodologies and other aspects are not mandatory or significant, and the mechanisms that implement the present invention or its features may have different names, divisions, and/or formats.

The command queue unit 202 is a buffer and software, code, or routines for receiving data and commands from one or more devices. In one implementation, the command queue unit 202 receives a data stream (data packets) from one or more devices and prepares them for storage in a non-volatile storage device (e.g. a storage device 110). In some implementations, the command queue unit 202 receives incoming data packets and temporarily stores the data packets into a memory buffer. In further implementations, the command queue unit 202 receives 4K data blocks and allocates them for storage in one or more storage devices 110. In other implementations, the command queue unit 202 may include a queue schedule that queues data blocks of data streams associated with a plurality of devices such that, the storage logic 104 processes the data blocks based on the data blocks corresponding position in the queue schedule. In some implementations, the command queue unit 202 receives a data stream from one or more devices and transmits the data stream to the data reduction unit 206 and/or one or more other components of the storage logic 104 based on the queue schedule.

The encryption unit 204 may include logic, software, code, or routines for encrypting data. In one implementation, the encryption unit 204 receives a data stream from the command queue unit 202 and encrypts the data stream. In some implementations, the encryption unit 204 receives a reduced data stream from the data reduction unit 206 and encrypts the data stream. In further implementations, the encryption unit 204 encrypts only a portion of a data stream and/or a set of data blocks associated with a data stream.

The encryption unit 204, in one implementation, encrypts data blocks associated with a data stream and/or reduced data stream responsive to instructions received from the command queue unit 202. For instance, if a user elects for encrypting data associated with user financials, while opting out from encrypting data associated with general data files (e.g. documents available to public, such as, magazines, newspaper articles, pictures, etc.), the command queue unit 202 receives instructions as to which file to encrypt and provides them to the encryption unit 204. In further implementations, the encryption unit 204 encrypts a data stream and/or reduced data stream based on encryption algorithms. An encryption algorithm can be user defined and/or known-encryption algorithms such as, but not limited to, hashing algorithms, symmetric key encryption algorithms, and/or public key encryption algorithms. In other implementations, the encryption unit 204 may transmit the encrypted data stream data reduction unit 206 to perform its acts and/or functionalities thereon.

The data reduction unit 206 may be logic, software, code, or routines for reducing/encoding a data stream by receiving a data block, processing the data block and outputs an encoded/reduced version of the data block as well as managing the corresponding reference blocks. In one implementation, the data reduction unit 206 receives incoming data and/or retrieves data, reduces/encodes a data stream, tracks data across system 100, clusters reference blocks into reference sets, retires reference blocks and/or reference sets using garbage collection, and updates information associated with a data stream. The particular naming and division of the modules, routines, features, attributes, methodologies and other aspects are not mandatory or significant, and the mechanisms that implement the present invention or its features may have different names, divisions and/or formats. As depicted in FIG. 2, the data reduction unit 206 may include a reduction unit 208, a counter unit 210, a media processor 214, and a memory 216 which may include reference sets 218.

In some implementations, the components 208, 210, 214, and 216 are electronically communicatively coupled for cooperation and communication with each other, and/or the other components of the storage logic 104. In some implementations, the components 208, 210, 214, and 216 may be stored in memory (e.g., main computer memory or random access memory) and include sets of instructions executable by a processor. In any of these implementations, the reduction unit 208, the counter unit 210, the media processor 214, and the memory 216 are adapted for cooperation and communication with a processor and other components of the storage logic 104.

The reduction unit 208 may include logic, software, code, or routines for reducing the amount of storage required to store data including encoding and decoding data blocks. In some implementations, the reduction unit 208 may reduce data using similarity based data deduplication. The reduction unit 208 may generate and analyze identifiers of data blocks associated with a data stream using Rabin Fingerprinting. For example, the reduction unit 208 may analyze information associated identifier information (e.g., digital signatures, fingerprints, etc.) of the data blocks associated with an incoming data stream by parsing a data store (e.g., stored in a storage device 110) for one or more reference blocks that match the data blocks of the incoming stream. The reduction unit 208 may then analyze the fingerprints by comparing the fingerprints of the data blocks to the fingerprints associated with the reference blocks.

In some implementations, the reduction unit 208 applies a similarity based algorithm to detect similarities between incoming data blocks and data previously stored in a storage device 110. The reduction unit 208 may identify a similarity between data blocks and previously stored data blocks using resemblance hashes (e.g., hash sketches) associated with the incoming data blocks and the previously stored data blocks.

In one implementation, reduction of a data stream, data block, and/or data packet by the reduction unit 208 can be based on a size of the corresponding data stream, data block, and/or the data packet. For example, a data stream, data block, and/or data packet received by the reduction unit 208 can be of a predefined size (e.g., 4 bytes, 4 kilobytes, etc.), and the reduction unit 208 may reduce the data stream, the data block, and/or the data packet based on the predefined size to a reduced size. In other implementations, the reduction unit 208 may reduce a data stream including data blocks based on a reduction algorithm such as, but not limited to, an encoding algorithm, a compression algorithm, deduplication algorithm, etc.

In some implementations, the reduction unit 208 encodes data blocks from an incoming data stream. The data stream may be associated with a file and the data blocks are content defined chunks of the file. The reduction unit 208 may determine a reference block for encoding data blocks based on a similarity between information associated with identifiers of the reference block and that of the data block. The identifier information may include information such as, content of the data blocks/reference set, content version (e.g. revisions), calendar dates associated with modifications to the content, data size, etc. In further implementations, encoding data blocks of a data stream may include applying an encoding algorithm to the data blocks of the data stream. A non-limiting example of an encoding algorithm, may include, but is not limited to, a deduplication/compression algorithm.

The counter unit 210 may include a storage register or memory and logic or routines for assigning a count associated with data. In some implementations, the counter unit 210 updates a use count of reference blocks and/or reference sets (e.g., during a write operation). For example, the counter unit 210 may track the number of times reference blocks and/or reference sets are used. In one implementation, a use count variable is assigned to a reference set. The use count variable of the new reference set may indicate a data recall number associated with a number of times data blocks or sets of data blocks reference the reference set.

The media processor 214 may include logic, software, code, or routines for determining a dependency of one or more data blocks to one or more reference sets and/or reference blocks. A dependency of one or more data blocks to one or more reference sets may reflect a common reconstruction/encoding dependency of one or more data blocks to one or more reference sets for call back. For instance, a data block (i.e. an encoded data block) may rely on a reference set for reconstructing the original data block such that the original information associated with the original data block (e.g., the un-encoded data block) can be provided for presentation to a client device. Additional operations of the media processor 214 are discussed elsewhere herein.

The memory 216 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with a processor. The memory 216 may store instructions and data, including, for example, an operating system, hardware drivers, other software applications, modules, components of the storage logic 104, databases, etc. For example, the memory 216 may store and provide access to reference sets 218. In some implementations, the memory 216 may include a non-transitory memory such as a dynamic random access memory (DRAM) device, a static random access memory (SRAM) device, or some other memory devices.

Reference sets 218 may be stored in the memory 216, the storage devices 110, or both. The reference sets 218 should also be stored in the storage devices 110, so that they may be recovered or initiated after a shutdown of the storage devices 110. In some instances, the reference sets 218 may be synced between the memory 216 and the storage devices 110, for example, periodically or based on some trigger. Reference sets define groups of reference blocks against which data blocks are encoded and decoded. A reference set may include a mapping of which data blocks belong to that reference set. For example, in some implementations, a reference set includes a bitmap or a binary number where each bit maps whether a reference block corresponding to that bit is included in the reference set. In some instances, when the bitmap for a particular reference set is zero (e.g., no reference blocks are associated with the reference set) the reference set may be deleted. In some implementations, the reference sets 218 may also include an indication of segments in the storage device 110 that use one or more reference blocks in the reference set for encoding/decoding, according to the techniques described herein.

The submission queue unit 220 may include software, code, logic, or routines for queuing data for storage. In one implementation, the submission queue unit 220 receives data (e.g. data block) and temporally stores the data into a memory buffer (not shown). For instance, the submission queue unit 220 can temporarily store a data stream in a memory buffer while, waiting for one or more components to complete processing of other tasks, before transmitting the data stream to the one or more components to perform its acts and/or functionalities thereon. In some implementations, the submission queue unit 220 receives data blocks and allocates the data blocks for storage in one or more storage devices 110. In further implementations, the submission queue unit 220 receives a data stream from the data reduction unit 206 and transmits the data stream to the storage devices 110 for storage.

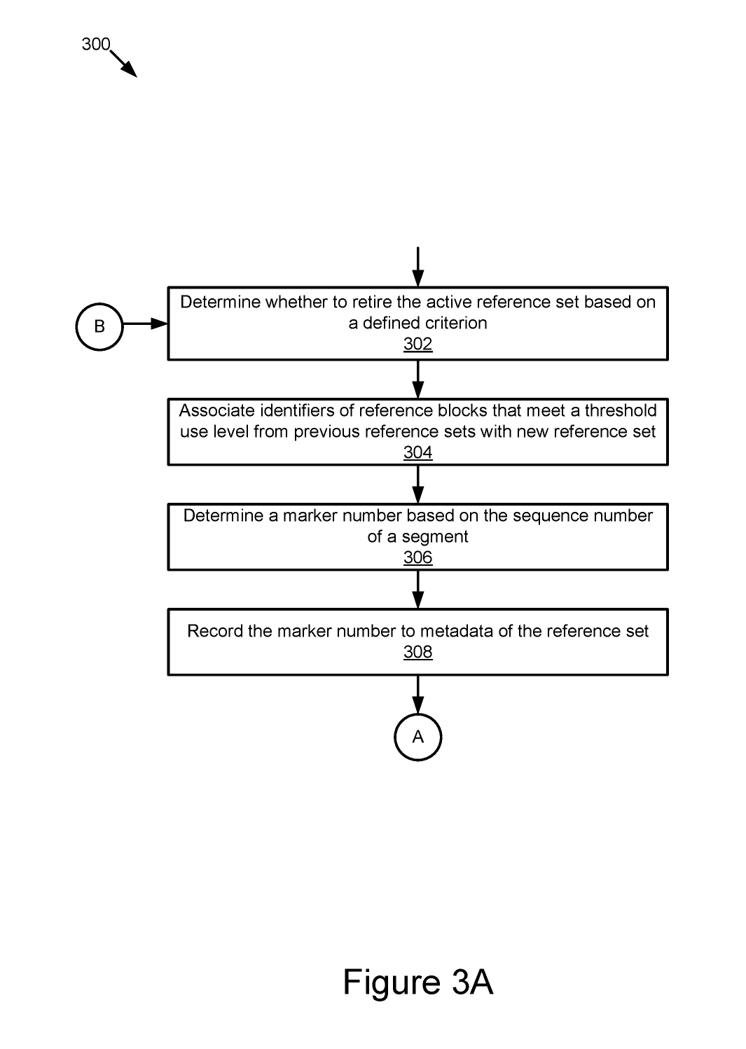

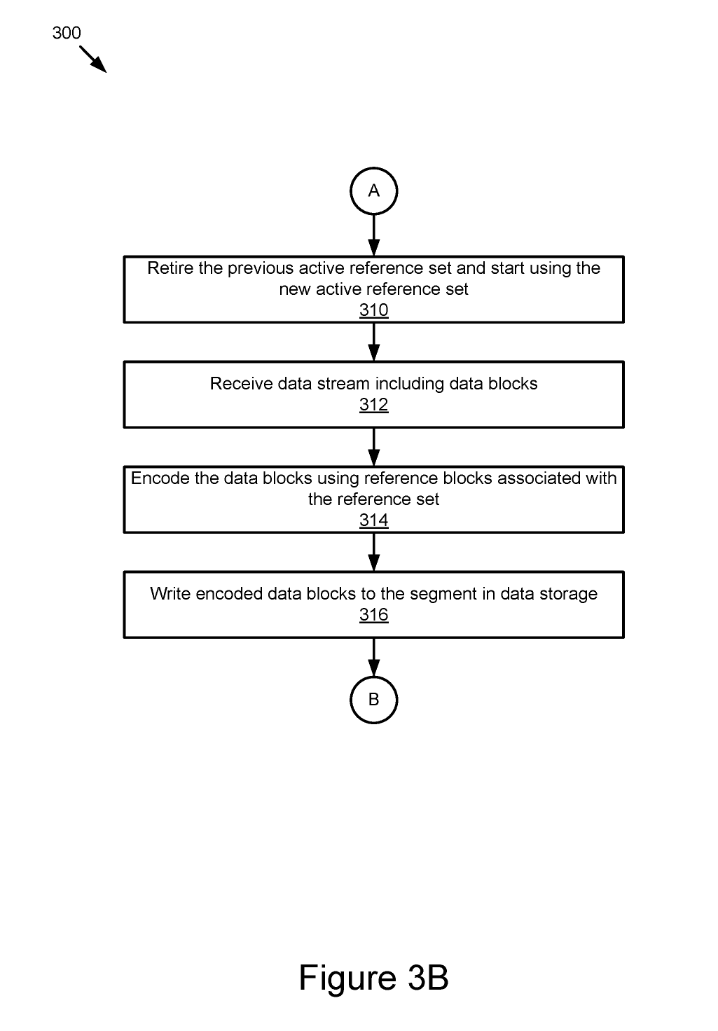

FIGS. 3A and 3B are flow charts of an example method 300 for creating a new active reference set and managing encoded data blocks associated with the new active reference set. In similarity based deduplication algorithms, a set of reference blocks represents the content of the data stream being deduplicated. These reference blocks are used as a template against which other data blocks are deduplicated. When a deduplicated data block is recalled from storage, the encoded data block is fetched from the storage device 110 and combined with the reference data in the reference block to reproduce the original data block. In order to reduce the computer resources required to track the association between a data block and the appropriate reference block, reference blocks are tracked in the aggregate in a reference set.

In some implementations, the media processor 214 may track reference blocks to determine whether the reference blocks are hot or stale. For example, a hot reference block is used to encode an incoming data stream at a threshold frequency and a stale reference block is used less than the threshold frequency. In some implementations, the media processor 214 may track the relevance of the currently active reference set to the incoming data stream. Once enough data blocks in the currently active reference set are stale, or no longer being used to encode incoming data blocks, the media processor 214 may retire the currently active reference set and create a new active reference set.

At 302, the media processor 214 determines whether to retire the active reference set based on a defined criterion. As the nature of the incoming data stream changes, the set of reference blocks also changes in order to ensure that the reference blocks in the set are a good representation of the incoming data stream. Although, according to the techniques described herein, reference blocks may be added to an active reference set, it is desirable to avoid a large quantity of stale reference blocks in the active reference set, so an active reference set may be retired. In some implementations, the criterion includes that the incoming data stream has changed to an extent that a certain percentage or quantity of the data blocks in that reference set are no longer being used to encode new data blocks (e.g., the reference blocks are stale). For example, if a defined threshold quantity of reference blocks have not been used to encode data blocks in the incoming stream for a defined duration, the reference set may be retired, so that a new active reference set includes fewer stale reference blocks.

Each deduplicated data block is associated with the reference block(s) against which it was reduced, so that on subsequent recall of the stored data block, it can be correctly assembled back into original form. Reference blocks should remain available as long as some data block potentially needs them. Although, a reference set is no longer the active reference set, the reference blocks in the set may still be used to decode data blocks that were previously encoded with the reference blocks in that reference set. Thus, a no longer active reference set should be maintained in the storage device 110 even after it is retired, so that those data blocks that were encoded using that reference set may be un-encoded.

At 304, the media processor 214 associates (e.g., carries forward an identifier) identifiers of reference blocks that meet a threshold use level from previous reference sets with the new reference set. Once reference blocks are aggregated into reference sets, it is possible that only a subset of a reference set becomes irrelevant due to a changing data stream. For example, in a reference set of 10000 reference blocks that has been in use for the last hour, it is possible that 500 of them are not getting any reference hits in which case these 500 reference blocks should be retired from the active reference set and the active reference set is populated with new reference blocks that are more relevant to the incoming data stream. Because stale reference blocks may still be required to decode stored data blocks, an active reference set is retired and a new active reference set is generated that excludes the stale reference sets. However, because some of the reference blocks are still hot (e.g., the 9500 of the 10000 reference blocks in the example), they should be carried forward to the new active reference set in order to be used to continue encoding data blocks in the incoming data stream.

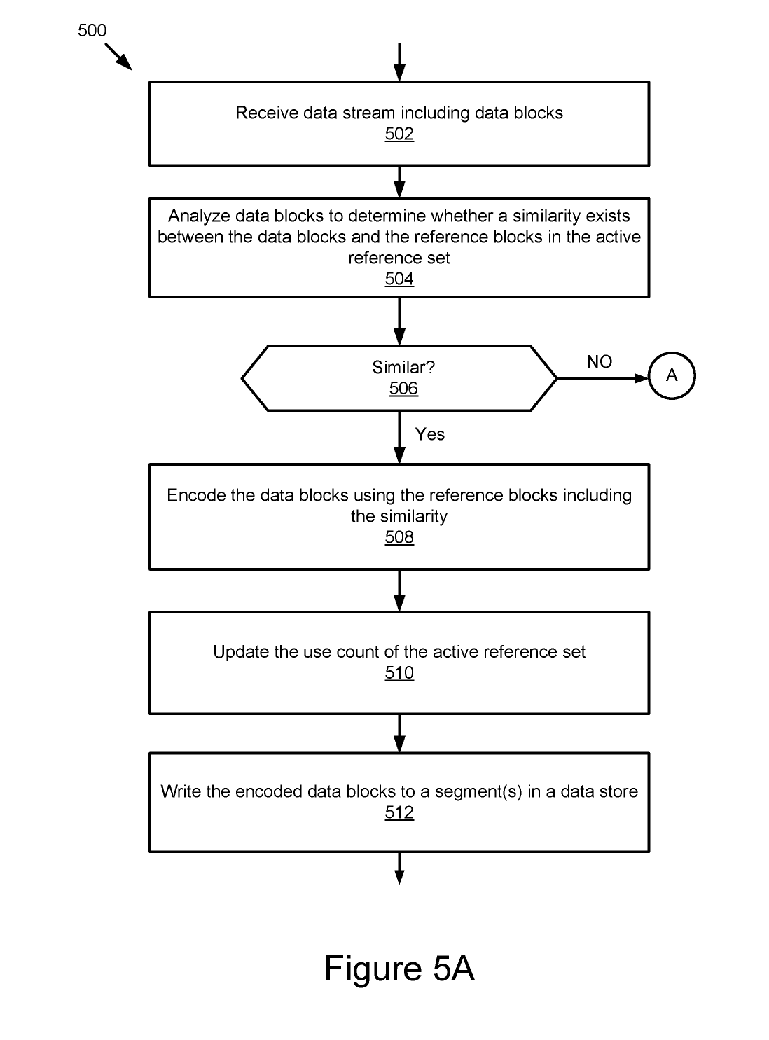

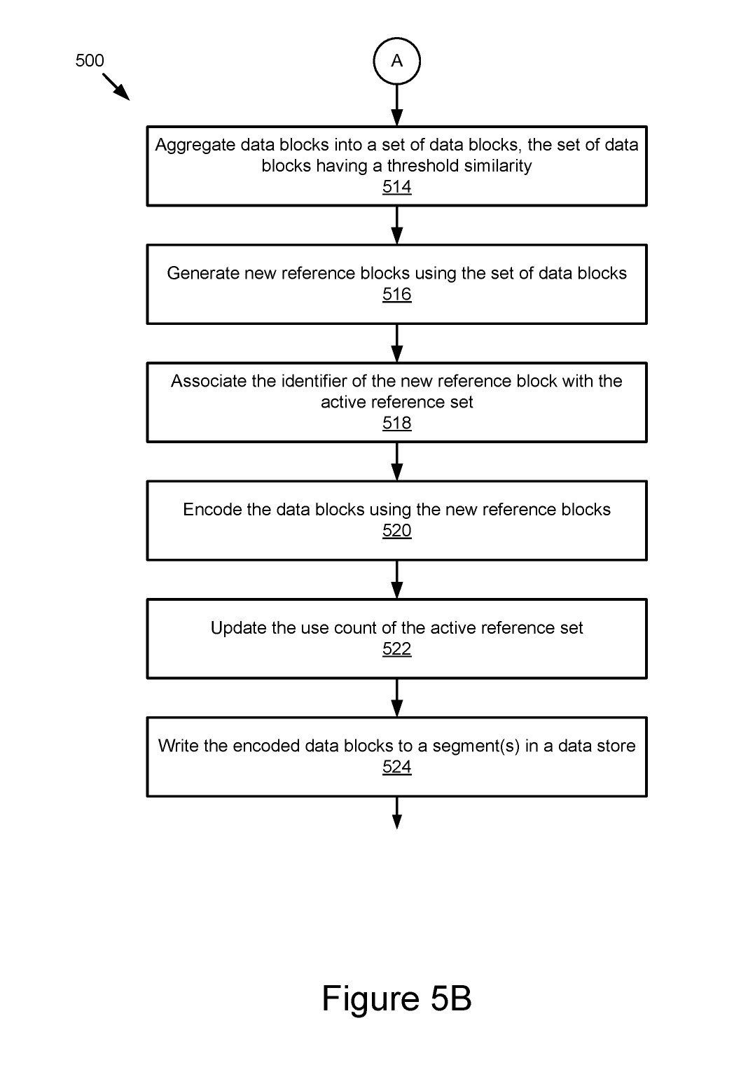

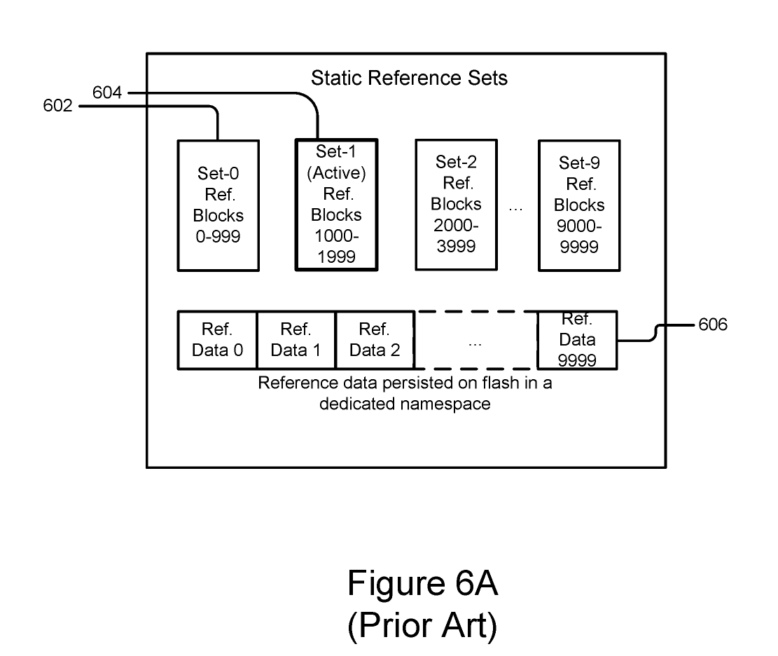

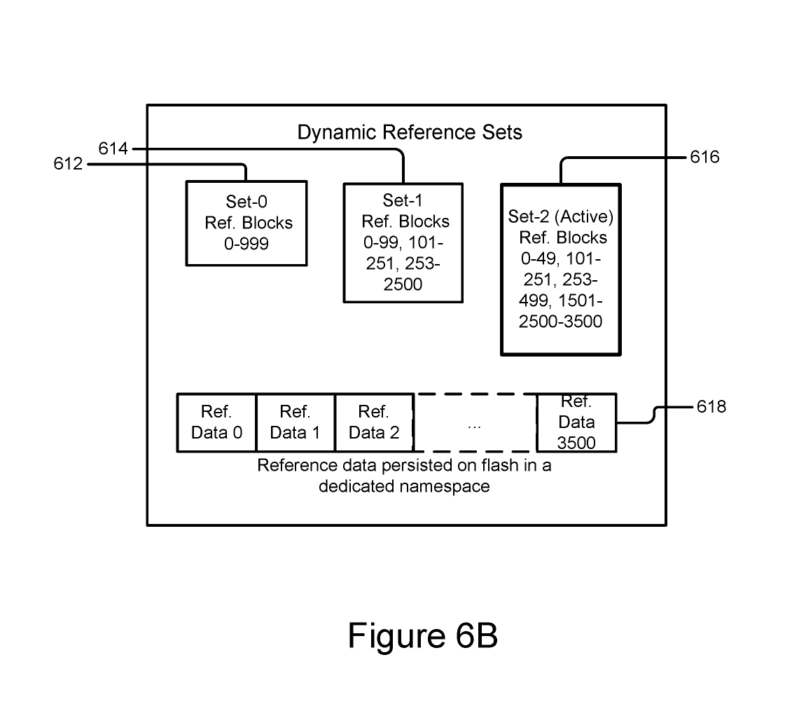

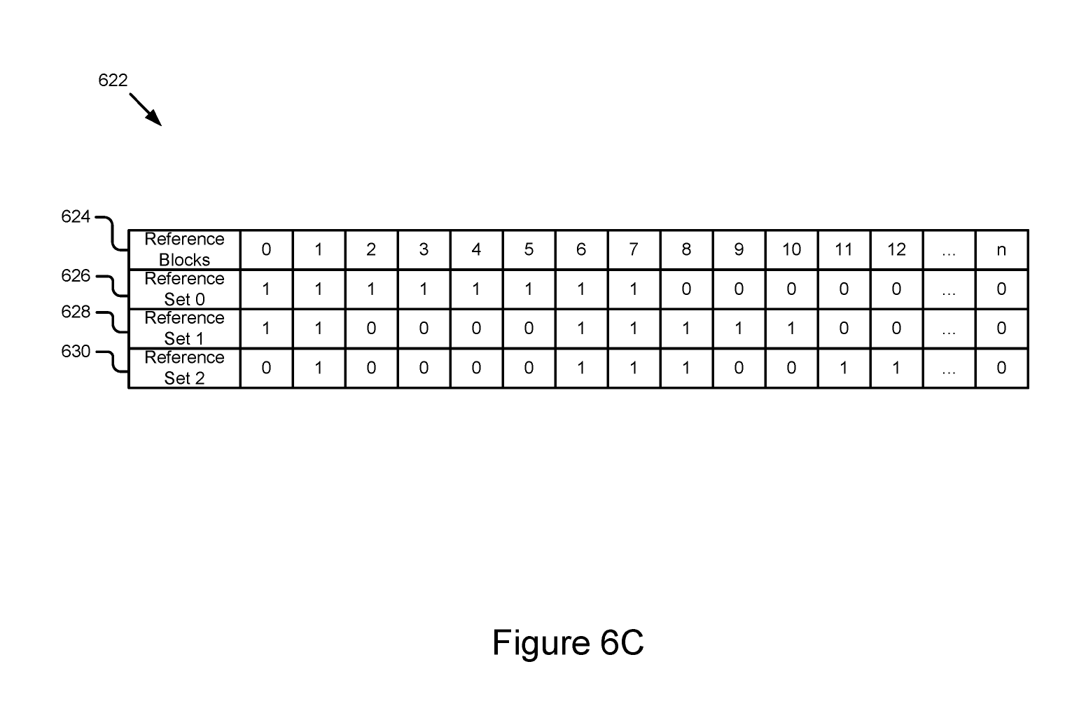

The techniques described herein allow hot reference blocks to be carried forward to a new active reference set without copying reference data of the reference blocks or changing their identification. This is particularly beneficial during garbage collection, so that there are neither an excessively large number of duplicate reference blocks in the active reference set nor do the encoded data blocks need to be decoded and then re-encoded using new reference blocks (e.g., during garbage collection). Assigning and carrying forward reference blocks is described in further detail in reference to FIGS. 5A-6B.

At 306, the media processor 214 determines a marker number based on the sequence number of a segment and at 308, the media processor 214, records the marker number to metadata of the reference set (e.g., on the storage device 110 and/or in memory 216). As described above, a segment is a portion of storage space in a storage device 110. A segment may be a contiguous physical area of storage media (e.g., flash memory) that is written in log manner (e.g., a system allocates a physical chunk, writes the chunk from the top to the bottom, and then switches to the next chunk). The media processor 214 can use the sequential ordering of segments (e.g., segment sequence numbers) to determine a marker, which is used to track which data blocks are encoded with which reference sets.

Segments only need to be recorded when a reference set is started instead of each time a segment is started. By recording segments in a reference set rather than recording reference sets in segments, far less data and write cycles are used, because segments change far more frequently than reference sets.

For example, let us say that there is a new reference set Rₙ that needs to be activated at time t₀ and the segment sequence number active at this point is S(t₀). The marker M(t₀) at this point of time is defined as S(t₀). At a future point of time t₁, let us say a new reference set Rₙ₊₁ needs to be activated. The marker M(t₁) at this point would consist of S(t₁) that satisfies S(t₁)>=S(t₀). Using markers M(t₀) and M(t₁) we can unambiguously imply that segments with sequence number between S(t₀) and S(t₁) belong to reference set R. More generically, in case there are multiple active segments (e.g., segments may be written in parallel for performance reasons), the marker M(t) is defined as a set of sequence numbers per active segment stream (i.e. M(t)={S1(t), S2(t), . . . Sₙ(t)} for an n segment stream configuration.

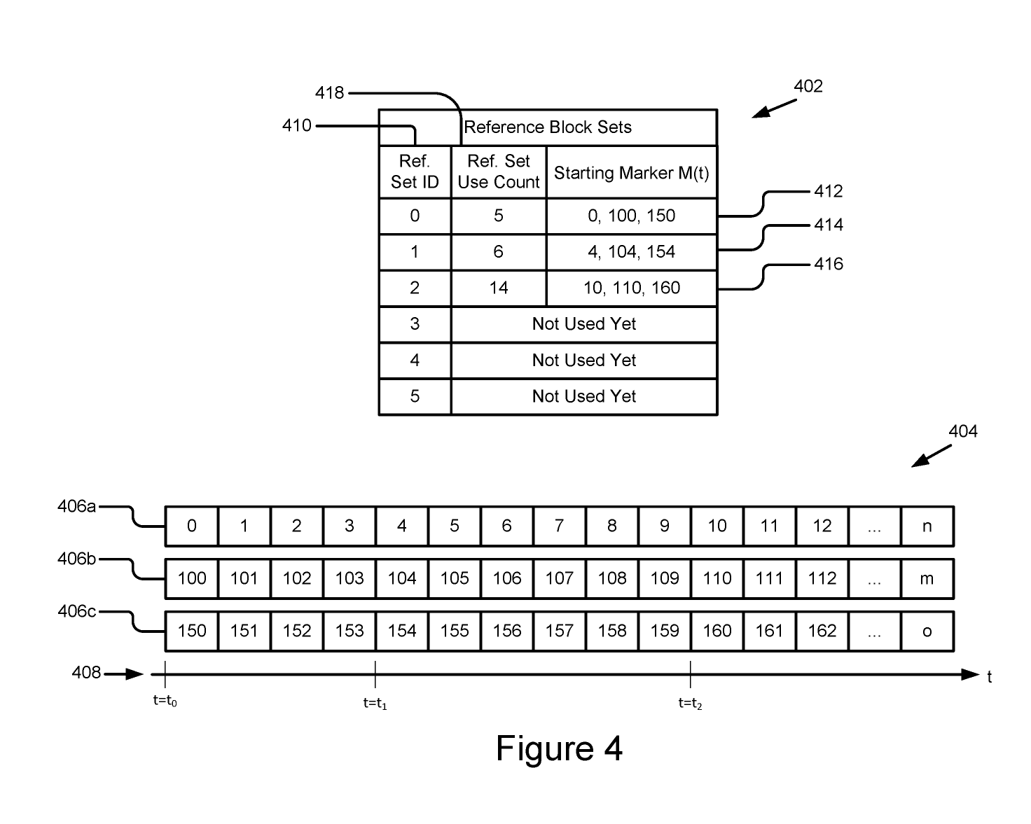

FIG. 4 is a graphical representation illustrating an example data organization where markers are determined based on segment sequence numbers and saved to a reference set (e.g., to metadata of a reference set). FIG. 4 illustrates a chart 402 showing example markers assigned to reference sets and a second chart 404 showing example segment streams being written sequentially in parallel.

The chart 402 is an illustration of how data, such as markers are assigned to reference sets. In some instances, a data structure containing the data of chart 402 exists in storage (e.g., a storage device 110), however the chart 402 is provided primarily for ease of description and illustration. For example, one or more use counts and markers may be stored along with the reference set to which they are relevant (e.g., in metadata or some other component of a reference set).

The chart 404 shows multiple segment streams 406a, 406b, and 406c simultaneously in use with each segment stream having a segment in the process of being written to at a given time t, illustrated by the timeline 408. Each segment in each segment stream 406a, 406b, and 406c is associated with a monotonically increasing segment number. The timeline 408 includes switch times t=t₀, t₁, and t₂, which indicate the times at which a new active reference set is started (e.g., when the first segment in the new active reference set is written).

The chart 402 shows an example series of reference sets with example identification numbers in column 410. The techniques described herein propose storing a marker against each reference set in reference set metadata. The marker, as described above, is based on the monotonically increasing sequence number of a segment. For instance, example metadata of reference sets corresponding to example reference set IDs 0, 1, and 2 are illustrated in rows 412, 414, and 416, respectively. The reference set illustrated in row 412 was first used to write segments at time t=t₀, so the first segments using that reference set are recorded against the reference set, for example, markers based on segment sequence numbers 0, 100, and 150. The reference set illustrated in row 414 was first used to write segments at time t=t₁, so the first segments using that reference set are recorded against the reference set, for example, markers based on segment sequence numbers 4, 104, and 154. The reference set illustrated in row 416 was first used to write segments at time t=t₂, so the first segments using that reference set are recorded against the reference set, for example, markers based on segment sequence numbers 10, 110, and 160. It should also be noted that the number of segments using each reference set may not be static, because reference set boundaries are elastic and the incoming data stream may change irregularly, as described elsewhere herein.

The chart 402 also shows, in column 418, example reference set use counts. Reference set use counts are used in some implementations to determine when a reference set may be deleted. For example, if the reference set use count for a reference set is below a threshold (e.g., equal to 0), that reference set may be deleted during garbage collection.

These techniques for storing a marker corresponding to the first segment encoded using a reference set provides a number of benefits. Some such benefits include that minimal metadata is updated when a reference set is created, easier recovery from an unplanned shut down due to the minimal metadata associated with the time of creation of the reference set, and a decrease in I/O latency because the creation/activation of a new reference set can be done as a non I/O path operation.

Returning to FIGS. 3A-3B, at 310, the media processor 214 retires the previous active reference set and starts using the new active reference set. In some implementations, retiring one reference set and starting a new one is performed by marking the retiring reference set as retired and/or the new reference set as active. Switching active reference sets may be a synchronous operation performed in the background. As described above, because the switch to the new active reference set is not in the I/O path, it may be performed more slowly without causing I/O latency. Additionally, because the new reference set is not used until it is stored in the storage device 110, an unplanned shutdown is much less likely to cause data corruption.

Incoming data blocks are not affected by switching reference sets because while the new reference set is being prepared, the retiring active reference set is still used until the point where the new reference set is activated. In some implementations, at the point when the new active reference set has been updated to storage in the storage device 110 and the writes have been completed, the incoming writes are be switched to the new active reference set. It should be understood that the reference sets should be maintained in data storage (e.g., in the storage device 110) in case of an unplanned shutdown.

At 312 and 314, the reduction unit 208 receives the data stream including data blocks and encodes the data blocks using reference blocks associated with the reference set (e.g., the reduction unit 208 may receive the data stream from the command queue unit 202). The reduction unit 208 encodes each data block using a reference set stored in a non-transitory data store (e.g., the storage device 110). Further, encoding of each data block of the set of data blocks may include using an encoding algorithm. A non-limiting example of an encoding algorithm, may include an encoding algorithm implementing deduplication/compression. The reduction unit 208 may then transmit the encoded data blocks of the set of data blocks to the submission queue unit 220. At 316, submission queue unit 220 writes encoded data blocks to the segment in data storage (e.g., the reduction unit 208 and/or media processor 214 may send the encoded data blocks to the submission queue unit 220 for storage). After 316, the method 300 may continue in a loop back to 302 where it is determined whether to retire the new active reference set.

It should also be understood that the operations described above may be performed by different components of the storage logic 104 and/or in a different order than that described. For example, a marker may be determined and/or saved to the new active reference set's metadata at any point of the method 300.

FIGS. 5A and 5B are flow charts of an example method 500 for encoding data blocks and aggregating corresponding reference blocks into reference sets. At 502, the reduction unit 208 receives a data stream including data blocks and, at 504, the reduction unit 208 analyzes data blocks to determine whether a similarity exists between the data blocks and the active reference set (e.g., a similarity between the data blocks and past data blocks encoded using reference blocks, and reference blocks, and fingerprints, etc., of reference blocks). For example, the reduction unit 208 may utilize an encoding algorithm to identify similarities between each data block of the set of data blocks associated with the data stream and the reference set stored in in the storage device 110. The similarities may include, but are not limited to, a degree of similarity between data content (e.g. content-defined chunks of each data block) and/or identifier information associated with each data block of the set of the data blocks and data content and/or identifier information associated with the reference set.

In some implementations, the reduction unit 208 can user a similarity-based algorithm to detect resemblance hashes (e.g. sketches) which have the property that similar data blocks and reference sets have similar resemblance hashes (e.g. sketches). Therefore, if the set of data blocks are similar based on corresponding resemblance hashes (e.g. sketches) to an existing reference set stored in storage, it can be encoded relative to the existing reference set.

If at 506, the reduction unit 208 determines that the incoming data blocks are similar, then the method 500 continues to 508, where the reduction unit 208 encodes the data blocks using the reference blocks including the similarity. In some implementations, data blocks can be segmented into chunks of data blocks in which the chunks of data blocks may be encoded exclusively. In one implementation, the reduction unit 208 may encode each data block of the new set of data blocks using an encoding algorithm (e.g. deduplication/compression algorithm). An encoding algorithm may include, but is not limited to, delta encoding, resemblance encoding, and delta-self compression.

At 510, the counter unit 210 may update the use count of the active reference set. For example, as described above, the counter unit 210 may track the number of times reference blocks and/or reference sets are used. In one implementation, a use count variable is assigned to the new reference set. The use count variable of the new reference set may indicate a data recall number associated with a number of times data blocks or sets of data blocks reference the new reference set. In further implementations, the use count variable may be part of the hash and/or a header associated with the reference set.

In some implementations, a reference set may be satisfied for deletion when a count of the use count variable of the reference set decrements to zero. A use count variable of zero may indicate that no data blocks or sets of data blocks rely on a (e.g. reference to a) corresponding stored reference set for regeneration. In further implementations, the media processor 214 may cause a reference set to be deleted based on the use count variable. For instance, after reaching the certain count, the media processor 214 can cause the reference set to be deleted by applying a garbage collection algorithm (and/or any other algorithm well-known in the art for data storage cleanup) on the reference set.

At 512, the submission queue unit 220 writes the encoded data blocks to one or more segments in the storage device 110.

If the reduction unit 208 determines at 506 that the incoming data blocks are not similar to existing reference blocks (e.g., similar to the data blocks represented by the existing reference blocks), then the method 500 continues to 514, where the reduction unit 208 aggregates data blocks into a set of data blocks, the set of data blocks having a threshold similarity to each other. The data blocks are aggregated based on a similarity criterion and differentiate from the reference blocks in the active reference set. A criterion may include, but is not limited to, similarity determinations, as described elsewhere herein, content associated with each data block, administrator defined rules, data size consideration for data blocks and/or sets of data blocks, random selection of hashes associated with each data block, etc. For instance, a set of data blocks may be aggregated together based on the data size of each corresponding data block being within predefined range. In some implementations, one or more data blocks may be aggregated based on a random selection. In further implementations, a plurality of criteria may be used for aggregation.

At 516, the reduction unit 208 generates new reference blocks using the set of data blocks. In one implementation, the encoding engine 310 generates a new reference block based on the one or more data blocks sharing content that is within a degree of similarity between each of the set of data blocks. In some implementations, responsive to generating the new reference block, the reduction unit 208 may generate an identifier (e.g. fingerprint, hash value, etc.) for the new reference block, although it should be understood that other implementations for creating a reference block are possible.

At 518, the reduction unit 208 and/or the media processor 214 associates the new reference blocks with the active reference set (e.g., by adding an identifier of the new reference blocks to metadata of the active reference set). In some implementations, the association between reference blocks may be maintained in the metadata of each reference set or in a specific reference association file. For example, in some implementations a reference set has a bitmap indicating whether each reference block is part of that reference set and therefore may be used to encode or decode the data blocks stored in segments that use that reference set for encoding, as described above.

At 520, 522, and 524, the storage logic 104 encodes the data blocks using the new reference blocks, updates the use count of the active reference set, and writes the encoded data blocks to one or more segments in a data store (e.g., the storage device 110) in the same or similar ways to the operations at 508, 510, and 512, respectively.

FIG. 6A is a graphical representation illustrating an example prior art data organization for static reference sets. The example of FIG. 6A either stores reference blocks in each reference set or may track reference blocks in static reference sets. The example illustrates a fixed number of reference blocks and an option to statically assign a range of reference blocks to a reference set. For example, in a system with 10,000 reference blocks (illustrated at 606), one could statically partition reference block 0 . . . 999 as reference set 0 (illustrated at 602), 1000 . . . 1999 as reference set 1 (illustrated at 604) and so on. The reference blocks 606 may include reference data organized according to sequential identification numbers. If reference data is used in a new reference set, it is copied and assigned a new sequential identification number.

The example of FIG. 6A results in unnecessary processing during garbage collection especially in case where the incoming data pattern is not changing very often. Let us consider a reference set 0 (at 602) as a reference set that is used for deduplication. Based on access statistics, suppose reference blocks 100 and 252 are not getting deduplication hits and hence the system decides to eliminate these reference blocks from the active reference set. Because, blocks 100 and 252 may already have data blocks in the past referring to them, the only way to eliminate these reference blocks is to create a new active reference set and move reference data from blocks 0-999, except 100 and 252, into a new active reference set (reference set 1 at 604). Due to the static assignment of reference sets to reference blocks, moving data from reference blocks 0-999 is only possible by reading reference data from reference set 0 and writing these against different reference block numbers (e.g., 1000-1997), thereby eliminating 100 and 252.

When garbage collection runs, any data block referring to a reference block number 0-999 would see that its reference block is no longer part of the active reference set and would have to re-encode data based on the current active reference set consisting of reference blocks 1000-1999. It can be seen that this re-encoding was unnecessary since reference blocks 1000-1997 have the same data that existed earlier in reference blocks 0-999. Because a data block refers to a particular reference block, if a reference set doesn't have the reference block, then the encoded data block would have to be undeduplicated in raw form and then rededuplicated with a new reference block.

FIG. 6B is a graphical representation illustrating an example data organization for dynamic reference sets according to the techniques described herein. The example of FIG. 6B, dynamically associates reference blocks and reference sets by storing metadata against each reference set reflecting the association. For example, metadata may be in the form of a membership bitmap (e.g., as described in reference to FIG. 6C) that remembers which reference block is currently part of which reference set. With this approach, the example of FIG. 6A could carry forward reference data in 0-99, 101-251, and 253-999 from a reference set 0 (at 612) to a new reference set 1 (at 614) by appropriately remembering the carried forward reference blocks in the membership bitmap of reference set 1. For example, reference set 1 may include pointers to its reference blocks, so the reference data in those reference blocks does not need to be copied as part of the reference set generation. Additionally, reference set 1 is elastically sized, so it may include additional reference blocks 100-2500 added for the incoming data stream. In some instances, due to the way the reference blocks are carried forward and assigned to reference sets, the reference blocks (e.g., identification numbers or pointers of reference blocks) in a reference set are non-contiguous. Similarly, due to garbage collection of deleted reference blocks, the reference block identification numbers themselves may be non-contiguous.

FIG. 6B also includes a representation 618 of reference blocks stored in the storage device 110 (and/or in the memory 216). For example, the reference sets and reference blocks may be maintained in a storage device 110 for recovery in case of an unplanned shutdown; however, they may also be synced to memory 216 for rapid access. The representation 618 of the reference blocks indicates that the reference blocks may be stored in a separate location from the reference sets, but are referenced by the reference sets. In some implementations, the reference blocks may be written and stored in sequential order.

By way of further example, based on access statistics, suppose reference blocks 50-99 and 500-1500 of reference set 1 (at 614) are not getting deduplication hits and hence the system decides to eliminate these reference blocks from the active reference set. Hot reference blocks (0-49, 101-251, 253-499, and 1501-2500) from reference set 1 are moved forward to reference set 2. The reference blocks of the retired reference set 1 are still available by use of reference set 1 to decode data blocks encoded using reference set 1. Thanks to the dynamic association between reference blocks and reference sets, the reference data in the reference blocks to new reference blocks with new reference identifications, the switch to new active reference set 2 can be made quickly without copying the reference data to the new reference sets. For example, the media processor 214 creates/modifies the metadata of reference set 2 to include identifications of these carried forward blocks. In some instances, the media processor 214 creates/modifies a membership bitmap of reference set 2 to include indications for each of the carried forward reference blocks (0-49, 101-251, 253-499, and 1501-2500). Additionally, the membership bitmap may be elastically sized so that additional reference blocks may be added to the active reference set. For example, as new reference blocks are added (e.g., as described in reference to FIG. 5A-5B) the membership bitmap of the active reference set may be updated to include these new reference blocks.

When garbage collection runs, data blocks referring to those reference blocks that have been carried forward need not be decoded and re-encoded. For example, the data blocks encoded using reference blocks 0-49, 101-251, and 253-499 can be copied during garbage collection without being re-encoded due to the dynamic carry forward of reference blocks from reference set 0 to reference set 1 and again to reference set 2. For example, data blocks copied during garbage collection would see that their reference blocks still exist (e.g., the reference block identification is unchanged) and hence the data blocks would not be re-encoded during garbage collection, but are copied in encoded form. In the example of FIG. 6B, according to the techniques described herein, no unnecessary write cycles or re-encoding are performed during garbage collection thanks to the dynamic association of reference blocks and reference sets. In some instances, the garbage collection algorithm may be slightly modified to look at the fact that the referring block is part of the referring data set.

The example shown in FIG. 6B provides a number of benefits over that of FIG. 6A. For example, switching reference sets is fast because the carried forward reference data does not need to be read and then written against new reference blocks in new reference set. In another example, an active reference set is extendable while it is still active by updating the bitmap to add new reference blocks, so the need to switch active reference sets is minimized. In yet another example, an active reference set can have more reference blocks in it (while static partitioning restricts the number of reference blocks to a subset that can be part of current active reference set), so the number of reference blocks that can be used for deduplication is increased.

FIG. 6C is an illustration of a chart 622 including one or more example membership bitmaps. It should be noted that although the chart 622 includes membership bitmaps for three reference sets in one chart 622, membership bitmaps for reference sets may be stored separately with each reference set or combined in a single file. For example, in some implementations, each reference set includes a membership bitmap indicating which reference blocks belong to that reference set. It should be understood that although the chart illustrates a particular implementation of membership bitmaps, other implementations are possible. For example, in some implementations, a membership bitmap is a binary number where the n^{th} digit corresponds to the n^{th} reference block. In another example implementation, the membership bitmap may include pointers to the reference blocks.

A membership bitmap may be elastically sized or may encompass an entire potential group of reference blocks (e.g., 4,000 reference blocks would have a 4,000 bit long binary number or bitmap). The bitmap can be updated so the size of the active reference set can be expanded and also, so it can include reference blocks of previously active reference sets (e.g., multiple reference sets may refer to the same reference blocks). Because each reference set keeps track of the reference blocks in its metadata (e.g., in a bitmap), instead of each reference block keeping track of the reference set to which it belongs, the total metadata required to track the association is reduced.

The chart 622 includes a row 624 illustrating reference blocks and rows 626, 628, and 630 illustrating the memberships of the reference blocks in reference sets. Row 626 illustrates an example bitmap for a reference set 0 indicating that reference set 0 includes reference blocks 0-7, but not reference blocks 8-n. Row 628 illustrates an example bitmap for a reference set 1 indicating that reference set 1 includes reference blocks 0-1 and 6-10 but not reference blocks 2-5 or 11-n. As illustrated, reference blocks 0-1 and 6-7 have been carried forward from reference set 0 into reference set 1, but reference blocks 2-5 were not carried forward. Similarly, reference blocks 8-10 may have been added to reference set 1 after reference set 1 became the active reference set and were not carried forward from reference set 0. Row 630 illustrates an example bitmap for a reference set 2 indicating that reference set 2 includes reference blocks 1, 6-8, and 11-12 but not reference blocks 0, 2-5, 9-10, or n. As illustrated, reference blocks 1, and 6-7 have been carried forward from reference set 1 into reference set 2, but reference blocks 0 and 8-10 were not carried forward. Reference blocks 11-12 were not in the reference set 1, but are new in reference set 2. For example, reference blocks 11-12 may have been added after reference set 2 became the active reference set.

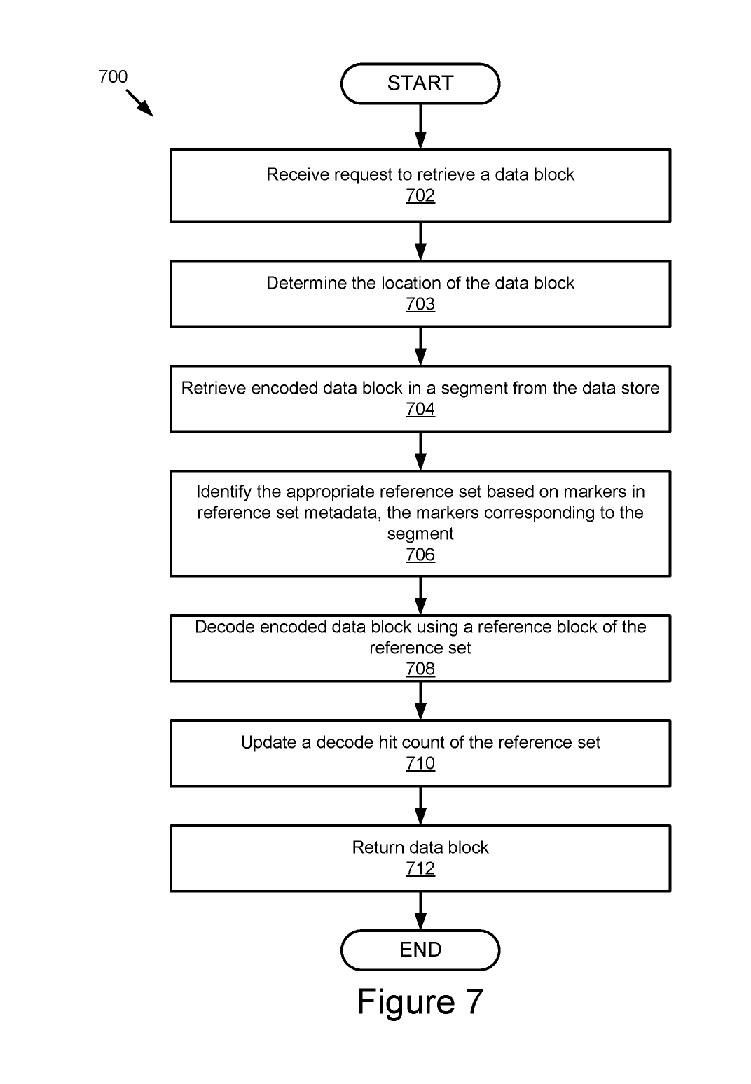

FIG. 7 is a flow chart of an example method 700 for retrieving an encoded data block from a data store (e.g., the storage device 110). At 702, the storage logic 104 receives a data recall request to retrieve a data block and at 703, the storage logic 104 determines the location of the data block on storage device 110. For instance, in a flash based system there may be a translation from a logical block to physical block number before the segment can be known, so there may be a mechanism to accurately get the reference block within the reference set for a data block. For example, the location of a data block on the storage device 110 may be found using forward map data structures that map a logical block to physical block number. At 704, the storage logic retrieves the encoded data block in a segment from the data store. At 706, the media processor 214 identifies the appropriate reference set based on markers in the reference set metadata, the markers corresponding to the segment (e.g., a segment sequence number). For example, the media processor 214 determines which segments, and therefore which data blocks, are associated with which reference sets based on the marker numbers in the metadata of the reference sets.

At 708, the reduction unit 208 decodes encoded data blocks using a reference block of the reference set. For example, the reduction unit 208 may reconstruct or undeduplicate the data block using the appropriate reference block (e.g., as may be referenced in the metadata of the data block).

At 710, the counter unit 210 may update a decode hit count of the reference set. In some implementations, the decode hit count variable can be part of a segment header associated with the segment of a non-transitory data store that stores the reference set called on for data recall operations, although other implementations are possible and contemplated by the techniques described herein. In some embodiment, the decode hit count indicates how many times the reference set or reference block has been read and/or decoded. The decode hit count variable may be used as a criterion for determining the hotness of a reference block (e.g., as described above). In further implementations, the decode hit count variable associated with a reference set can be stored independently in a records table in the storage device 110.

At 712, the storage logic 104 returns the decoded data block to the application or client device that requested recall of the data block.

Systems and methods for providing a highly reliable system for implementing cross device redundancy schemes are described herein. In the above description, for purposes of explanation, numerous specific details were set forth. It will be apparent, however, that the disclosed technologies can be practiced without any given subset of these specific details. In other instances, structures and devices are shown in block diagram form. For example, the disclosed technologies are described in some implementations above with reference to user interfaces and particular hardware. Moreover, the technologies disclosed above primarily in the context of on line services; however, the disclosed technologies apply to other data sources and other data types (e.g., collections of other resources for example images, audio, web pages).

Reference in the specification to “one implementation” or “an implementation” means that a particular feature, structure, or characteristic described in connection with the implementation is included in at least one implementation of the disclosed technologies. The appearances of the phrase “in one implementation” in various places in the specification are not necessarily all referring to the same implementation.

Some portions of the detailed descriptions above were presented in terms of processes and symbolic representations of operations on data bits within a computer memory. A process can generally be considered a self-consistent sequence of steps leading to a result. The steps may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers, or the like.

These and similar terms can be associated with the appropriate physical quantities and can be considered labels applied to these quantities. Unless specifically stated otherwise as apparent from the prior discussion, it is appreciated that throughout the description, discussions utilizing terms for example “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may include a general-purpose computer selectively activated or reconfigured by a computer program stored in the computer.

The disclosed technologies can take the form of an entirely hardware implementation, an entirely software implementation or an implementation containing both hardware and software elements. In some implementations, the technology is implemented in software, which includes but is not limited to firmware, resident software, microcode, etc.

Furthermore, the disclosed technologies can take the form of a computer program product accessible from a non-transitory computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A computing system or data processing system suitable for storing and/or executing program code will include at least one processor (e.g., a hardware processor) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the processes and displays presented herein may not be inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the disclosed technologies were not described with reference to any particular programming language. It will be appreciated that a variety of programming languages may be used to implement the teachings of the technologies as described herein.

The foregoing description of the implementations of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies be limited not by this detailed description. The present techniques and technologies may be implemented in other specific forms without departing from the spirit or essential characteristics thereof. Likewise, the particular naming and division of the modules, routines, features, attributes, methodologies and other aspects are not mandatory or significant, and the mechanisms that implement the present techniques and technologies or its features may have different names, divisions and/or formats. Furthermore, the modules, routines, features, attributes, methodologies and other aspects of the present technology can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future in computer programming. Additionally, the present techniques and technologies are in no way limited to implementation in any specific programming language, or for any specific operating system or environment. Accordingly, the disclosure of the present techniques and technologies is intended to be illustrative, but not limiting.

What is claimed is:

1. A method comprising:
associating identifiers of a plurality of reference blocks with a first reference set, the plurality of reference blocks including a first reference block having a first identifier;
selecting the first reference block of the plurality of reference blocks for continued use;
associating the first identifier of the first reference block with a second reference set, the second reference set having a second plurality of reference blocks, the first reference block being non-contiguous with the second plurality of reference blocks;
receiving an incoming data stream of data blocks; and
encoding the incoming data stream of data blocks using the second reference set.

2. The method of claim 1, further comprising:
storing a first encoded data block of the incoming data stream of data blocks in a first segment associated with the second reference set;
determining a marker number of the first segment associated with the second reference set; and
storing the marker number of the first segment in metadata of the second reference set.

3. The method of claim 2, wherein the marker number of the first segment associated with the second reference set includes a segment sequence number of the first segment, and the first segment is an initial segment to be written using the second reference set.

4. The method of claim 1, wherein the second reference set includes a dynamic quantity of reference blocks.

5. The method of claim 1, wherein associating the first identifier of the first reference block with the second reference set includes adding the first identifier of the first reference block to a membership bitmap of the second reference set.

6. The method of claim 1, further comprising:
generating a second reference block based on the incoming data stream, the second reference block having a second identifier; and
associating the second identifier of the second reference block with the second reference set.

7. The method of claim 1, further comprising determining to retire the first reference set based on a defined criterion, and wherein associating the first identifier of the first reference block with the second reference set is in response to the determination to retire the first reference set.

8. The method of claim 1, wherein encoding the incoming data stream of data blocks using the second reference set includes deduplicating a data block of the incoming stream of data blocks using the first reference block against a past data block encoded using the first reference block.

9. A system comprising:
a dynamic reference set for associating encoded data blocks to reference blocks, the dynamic reference set including a plurality of non-contiguous reference blocks;
a reduction unit having an input and an output for encoding data blocks using the reference blocks in the dynamic reference set, the input of the reduction unit coupled to receive data from a data source;
a media processor having an input and an output for dynamically associating identifiers of reference blocks with the dynamic reference sets, the input of the media processor coupled the reduction unit to receive reference blocks; and
a storage device capable of storing data, the storage device having an input and an output coupled to the reduction unit and the media processor for reading data from and storing data to the storage device.

10. The system of claim 9, further comprising:
the system further comprises a submission queue unit having an input and an output for storing an encoded first data block in a first segment associated with the dynamic reference set in the storage device the input of the submission queue unit coupled to the reduction unit and the output of the submission queue unit coupled to the storage device; and
wherein the media processor is further configured to determine a marker number of the first segment in the storage device, and associate the marker number of the first segment in metadata of the dynamic reference set.

11. The system of claim 10, wherein the marker number of the first segment associated with the dynamic reference set includes a segment sequence number of the first segment, and the first segment is an initial segment to be written using the dynamic reference set.

12. The system of claim 9, wherein the dynamic reference set is dynamically sized.

13. The system of claim 9, wherein the dynamic reference set includes a membership bitmap, the membership bitmap storing the association between reference sets and reference blocks.

14. The system of claim 9, further comprising;
a command queue unit having an input and an output for receiving a plurality of data blocks in an incoming data stream, the input of the command queue unit coupled to the data source and the output of the command queue unit coupled to the reduction unit; and
wherein the reduction unit is further configured to generate a new reference block based on the plurality of data blocks in the incoming data stream, the new reference block having a new identifier; and
wherein the media processor is further configured to associate the new identifier with the dynamic reference set.

15. The system of claim 9, wherein the media processor is further configured to determine to retire a first dynamic reference set based on a defined criterion, and associate identifiers of one or more reference blocks of the first dynamic reference set with a second dynamic reference set in response to the determination to retire the first dynamic reference set.

16. The system of claim 9, wherein the reduction unit is configured to deduplicate a first data block using a reference block against a second data block encoded using the reference block.

17. A method comprising:
receiving a data block;
encoding the data block using a reference block associated with a reference set;
storing the encoded data block in an initial segment in a storage device, the initial segment being a first segment encoded using the reference set;
determining a marker number of the initial segment based on a segment sequence number of the initial segment; and
recording an association of the marker number of the initial segment with the reference set in metadata of the reference set.

18. The method of claim 17, further comprising:
receiving a request to retrieve the data block from the storage device;
identifying the reference set based on the recorded association between the initial segment and the reference set in the metadata of the reference set;
decoding the encoded data block using the reference block to generate the data block; and
returning the data block.

19. The method of claim 17, wherein the reference set is dynamically sized and includes a plurality of non-contiguous reference blocks.

20. The method of claim 17, wherein the association between the reference block and the reference set is stored in a membership bitmap.
